(19) United States
(12) Patent Application Publication
(10) Pub. No.: US 2020/0160227 A1
(43) Pub. Date: May 21, 2020

(54) MODEL UPDATE BASED ON CHANGE IN EDGE DATA

(71) Applicant: General Electric Company, Schenectady, NY (US)

(72) Inventors: Shaopeng LIU, Clifton Park, NY (US); Colin PARRIS, Brookfield, CT (US); Xiao BIAN, Niskayuna, NY (US); Huan TAN, Clifton Park, NY (US); Kiersten RALSTON, Niskayuna, NY (US); Guiju SONG, Niskayuna, NY (US); Dayu HUANG, Niskayuna, NY (US)

(21) Appl. No.: 16/191,879

(22) Filed: Nov. 15, 2018

(51) Int. Cl. G06N 99/00

(52) U.S. Cl. CPC G06N 99/005; G06T 7/74

(57) ABSTRACT

The example embodiments are directed to a system for triggering a model update for an edge device in an IIoT network. In one example, the method may include one or more of receiving data of an operation performed by an industrial asset, the received data comprising input for a machine learning (ML) model associated with the industrial asset, determining that the received data comprises a change in data pattern with respect to a training data set which was used to previously train the ML model, storing the received data comprising the change in data pattern in a new data set, and in response to the new data set reaching a minimum threshold size, at least one of updating the ML model based on the new data set and transmitting a request to update the ML model based on the new data set.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

An industrial internet of things (IIoT) network incorporates machine learning and big data technologies to harness the sensor data, machine-to-machine (M2M) communication and automation technologies that have existed in industrial settings for years. The driving philosophy behind IIoT is that smart machines are better than humans at accurately and consistently capturing and communicating real-time data. This data enables companies to pick up on inefficiencies and problems sooner, saving time and money and supporting business intelligence (BI) efforts. IIoT holds great potential for quality control, sustainable and green practices, supply chain traceability and overall supply chain efficiency.

In an IIoT, edge devices sense or otherwise capture data and submit the data to a cloud platform or other central host. Edge devices may be used widely in a large variety of industrial applications. In a cloud-edge system, artificial intelligence (AI) models having machine learning capabilities are maintained in the cloud and operated based on key information that is collected from different edge devices. In particular, one edge device may run a few different AI models supported by the cloud for various problems, and on the other hand, one cloud model may support several different edge devices. This many-to-many relationship creates a challenge to a model and data management scheme. With the increasing number of AI models (that run in the cloud) and edge devices, various problems become critical. For example, a change of data pattern collected by edge devices may render the performance of the AI model diminished and unsatisfactory. Also, it can be difficult to know when to initiate a model update to characterize the newly emerged data stream/pattern or continue using the old model.

### SUMMARY

According to an aspect of an example embodiment, a method may include one or more of receiving data of an operation performed by an industrial asset, the received data comprising input for a machine learning (ML) model associated with the industrial asset, determining the received data comprises a change in data pattern with respect to a training data set used to previously train the ML model, storing the received data comprising the change in data pattern in a new data set, and, in response to the new data set reaching a minimum threshold size, at least one of updating the ML model based on the new data set and transmitting a request to update the ML model based on the new data set.

According to an aspect of another example embodiment, a computing system may include one or more of a storage device, and a processor configured to one or more of receive data of an operation performed by an industrial asset, the received data comprising input for a machine learning (ML) model associated with the industrial asset, determine the received data includes a change in data pattern with respect to a training data set used to previously train the ML model, and store the received data including the change in data pattern in a new data set within the storage device, wherein, in response to the new data set reaching a minimum threshold size, the processor is further configured to at least one of update the ML model based on the new data set and transmit a request to update the ML model based on the new data set.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating an edge system and a cloud platform performing an ML model update in accordance with an example embodiment.

FIG. 3A is a diagram illustrating a process of determining to perform an ML model update in accordance with example embodiments.

FIG. 3B is a diagram illustrating a process of an edge device generating a new data set in accordance with example embodiments.

FIG. 3C is a diagram illustrating a process of clustering of data within the new data set in accordance with example embodiments.

FIG. 4 is a diagram illustrating a method for determining to perform a ML model update in accordance with an example embodiment.

FIG. 5 is a diagram illustrating a computing system configured for use within any of the example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a cloud-edge system in which updates to a machine learning (ML) model (also referred to as artificial intelligence model) is automatically triggered based on a change in data detected from an operation of an industrial asset with respect to initial training data of the ML model. ML models may be used to evaluate data captured by the edge with respect to a trained/reference set of data that is usually a base line of a performance of the asset. ML models may be used to make predictions about an industrial asset such as when wear or damage has occurred to an asset, if instrument controls need to be changed based on external factors, if a part needs replacement, if materials should be ordered, and the like. ML models may operate based on time-series data, images, audio, and the like, which may be captured by sensors (pressure, acoustic, temperature, motion, imaging, acoustic, etc.), and the like.

ML models may be used to evaluate data captured by the edge with respect to a trained/reference set of data that is usually a base line of a performance of the asset. For example, ML models may be used to identify discriminate features which can be used to make predictions about an industrial asset such as when wear or damage has occurred to an asset, if instrument controls need to be changed based on external factors, if a part needs replacement, if materials should be ordered, and the like. For example, ML models may operate based on time-series data, images, audio, and the like, which may be captured by sensors (pressure, acoustic, temperature, motion, imaging, acoustic, etc.), and the like.

In the example of image data, the image data may be attempting to detect a specific feature from an industrial asset (e.g., damage to a surface of the asset, etc.) A machine learning model may be trained to identify how likely such a feature exists in an image. A result of the ML model output may be a data point for the image where the data point is arranged in a multi-dimensional feature space with a likelihood of the feature existing within the image being arranged on one axis (e.g., y axis) and time on another axis (e.g., x axis). As another example, time-series data may be used to monitor how a machine or equipment is operating over time. Time-series data may include temperature, pressure, speed, etc. Here, the ML model may be trained to identify how likely it is that the operation of the asset is normal or abnormal based on the incoming-time series data.

An ML model may be trained based on actual data from an industrial asset. Often, an initial training period occurs when an asset is established. However, over time, data being created or otherwise captured from an asset may change for various reasons. For example, machine and equipment assets may begin to deteriorate or wear-down creating a reduction in performance. As another example, unexpected changes in environment can cause unexpected changes to the data. As another example, maintenance operations and/or upgrades of parts and systems may occur creating improvements in the performance of the asset. The performance of the machine learning algorithms may deteriorate when data patterns within the edge data begin to stray from the data patterns of the initial training data.

The example embodiments improve upon the prior art by automating the process of model updates. For example, the edge-cloud system may determine a distance (e.g., a Euclidean distance) between data points of incoming edge data with respect to data patterns of the initial training data. When the incoming data differs from the training data by a predetermined distance, and for a predetermined amount of time (or number of data points), the edge-cloud system can trigger an automated update of the ML model.

To perform the ML model update, the edge-cloud system may generate a new data set of data points from received edge data which differ from the data pattern of the initial training data. A clustering program can run continuously on the new data set to identify clusters of continuous data points which differ by the predetermined distance from the data pattern in the initial training data set. When the clustering program identifies a cluster of data points within the new data set having a predetermined threshold size (e.g., 100 data points, etc.) the edge can request (or the cloud can automatically trigger) an update to the ML model. In response, the cloud may train a new ML model or updated an existing ML model based on the data within the new data set.

The process of training an ML model involves providing an ML algorithm (i.e., the learning algorithm) with training data to learn from. The term ML model refers to the model artifact that is created by the training process. The training data must contain the correct answer, which is known as a target or target attribute. The learning algorithm finds patterns in the training data that map the input data attributes to the target (i.e., the answer to predict), and it outputs an ML model that captures these patterns.

An ML model may be used to generate predictions on new data for which a target attribute is unknown. For example, an ML model may be trained to predict if corrosion has occurred on the surface of a gas flare stack based on image data captured of the gas flare stack by a camera from an unmanned aerial vehicle. Here, the training data for the ML model may contain images for which the target is provided (i.e., a label that tells whether an image depicts corrosion or no corrosion). A cloud platform may train an ML model by using this data, resulting in a model that attempts to predict whether a newly received image includes corrosion or not.

However, the types of corrosion or the areas of the gas flare stack where the corrosion occur may change causing the model to diminish in capacity and no longer predict accurately (e.g., at predetermined accuracy threshold) whether an image contains corrosion. The edge-cloud system described herein can prevent this diminishing capacity of the ML model by detecting changes in the underlying data before the ML model is rendered obsolete. Furthermore, the system may store the changing data in a new data set which can be used to train a new model or update an old model based on the existing data set combined with the new data set.

The system and method described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The edge-cloud system may be used in conjunction with applications and systems for managing machine and equipment assets and can be hosted within an IIoT. For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a mechanism for triggering an update to a ML model upon detection that the incoming data is no longer represented by the data pattern within the training data which was used to initially train the ML model.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

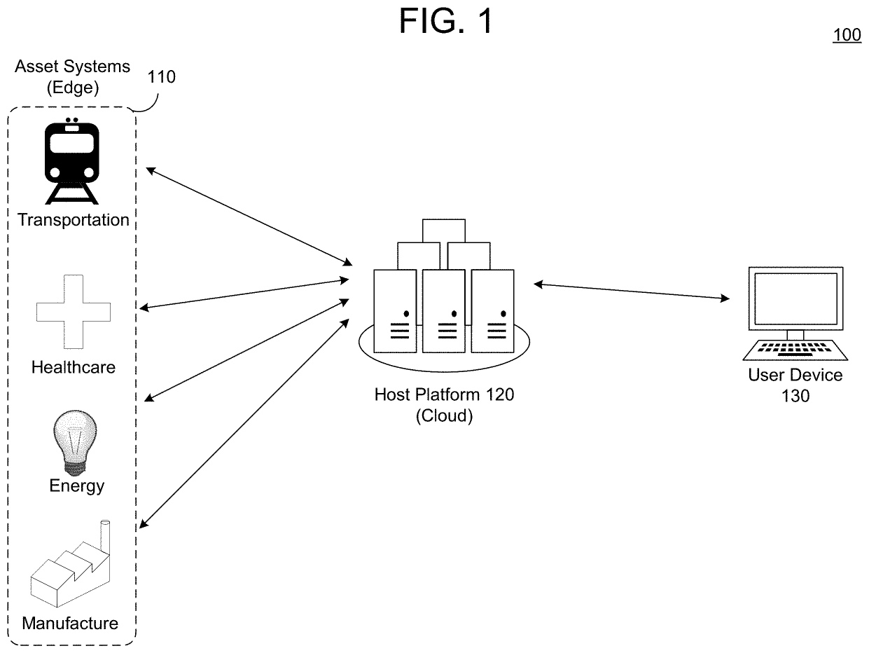

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.)

A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

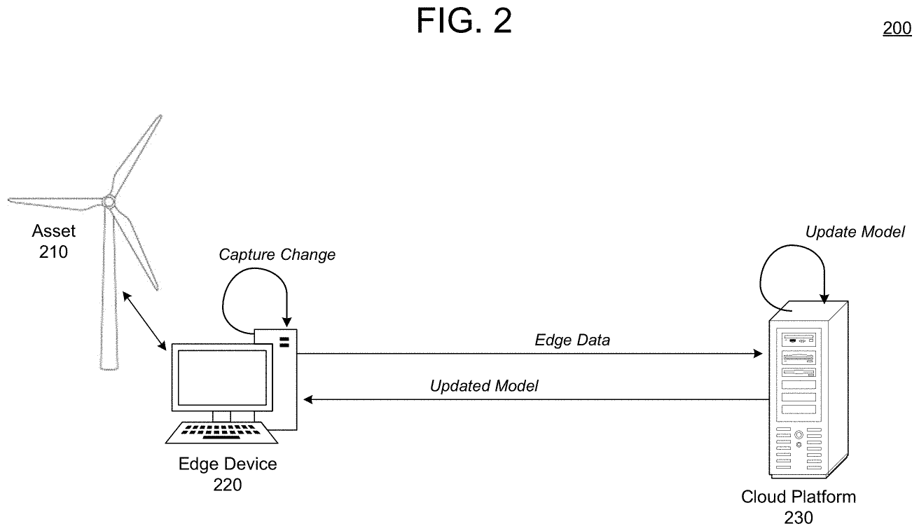

FIG. 2 illustrates a system 200 in which an edge device 220 and a cloud platform 230 perform an ML model update for a ML model that receives data created by an operation of an asset 210, in accordance with an example embodiment. Although shown as a wind turbine, the asset 210 may include any desirable asset such as a jet airplane, a locomotive, an elevator, a mining/drilling system, a gas flare stack, and the like. In this example, the asset 210 (or sensors sensing data of the asset 210) is coupled to (e.g., via a wired or wireless communication) the edge device 220. The edge device 220 may feed data to the cloud platform 230 at periodic or continuous intervals.

In some cases, the ML models may be stored on the edge device 220 attached or connected to the asset 210. As an example, the edge device 220 may be an edge PC coupled to the asset, an asset controlling computing system for controlling the asset, a gateway, etc.) The edge device 220 may receive views of data or other information about the asset as the data is captured by the sensors, cameras, gauges, etc. The cloud platform may also store and execute ML models associated with the operation of the asset 210. As one example, the edge device 220 may store a ML model that is specific to the asset 210 to which the edge device 220 is connected, and the cloud platform 230 may store a collaborative ML model which is generic to multiple assets or a farm of assets including the asset 210.

Initially, data captured of an operation of the asset 210 may be transmitted from the edge device 220 to the cloud platform 230 to train a ML model for use at the edge device 220. The captured data may detect sound, temperature, pressure, velocity, etc. As another example, the data may be an image captured of the asset itself and/or its surrounding environment. Once enough data has been received, the ML model may be trained by the cloud platform 230 and the ML model and the training data may be provided to the edge device 220 for future operations. In one example, the ML model may be used by the edge device 220 to detect discriminate data features that are to be sent back to the cloud platform 230 for analysis and processing. The data features may be detected based on two-dimensional graphs of the data with respect to time. The trained ML model may also be provided to other assets/edge devices for user when capturing data, and vice versa.

According to various embodiments, the edge device 220 may compare data received from the asset 210 (such as sensor data captured of an operation of the asset 210) with the training data that was used to train the ML model. When the incoming data deviates from the training data, a new data pattern may begin to emerge. The edge device 220 may detect the new data pattern by comparing a Euclidean distance of an incoming data point with respect to a data pattern of the training data. When the distance is greater than a predetermined distance, the edge device 220 may store the data point within a new data set. However, one data point (or even a few) deviating from the training data pattern may not be enough to trigger a change to the ML model because a few data points may just be outliers. Therefore, the edge device 220 may cluster data points within the new data set and compare cluster sizes to a predetermined threshold size. For example, if more than 50 data points are received consecutively that deviate from the training data pattern by the predetermined distance, the edge device 220 may transmit a request to the cloud platform 230 to update the ML model based on the new data pattern embodied within the new data set.

In response, the cloud platform 230 may receive the request, update the ML model based on the new data set, and transmit the updated ML model to the edge device 220. The cloud platform 230 may take multiple approaches to update an ML model. In one example, the new clustered data set may be an incremental input which can be used as an incremental learning set from which to update the existing model. As another example, a new model can be created based on the new data set, and the new model may be combined with the original model directly. As another example, the original training data set and the new data set may be merged. In this example, a model may be generated based on the merged combination of the data sets as a whole data set.

Also, it should be appreciated that the cloud platform 230 may perform the operations of the edge device 220. For example, the cloud platform may compare data received from the asset 210 with the training data that was used to train the ML model to determine whether the incoming data deviates from the training data by a predetermined distance, and a new data pattern exists. Furthermore, the cloud platform 230 may cluster the data points within the new data set until a predetermined size data set is achieved. In this example, the edge device 220 may provide the raw data from the asset 210 to the cloud platform 230 and the cloud platform 230 may perform the determination of a model update.

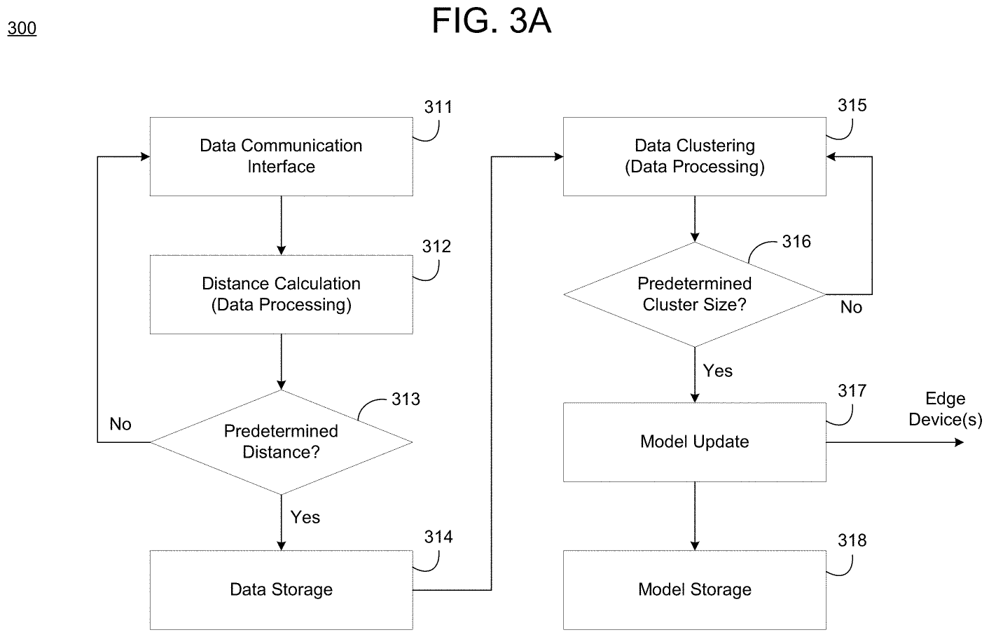

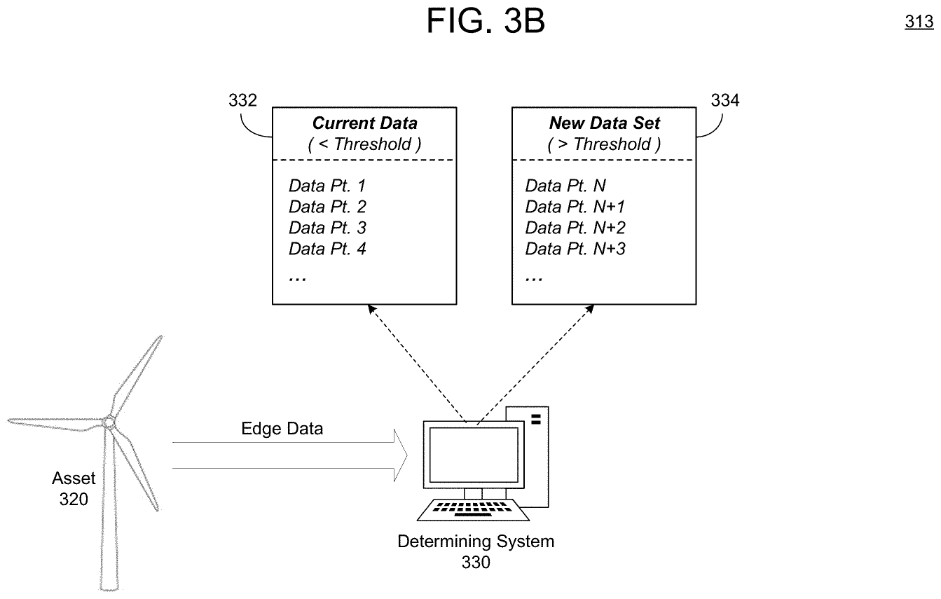

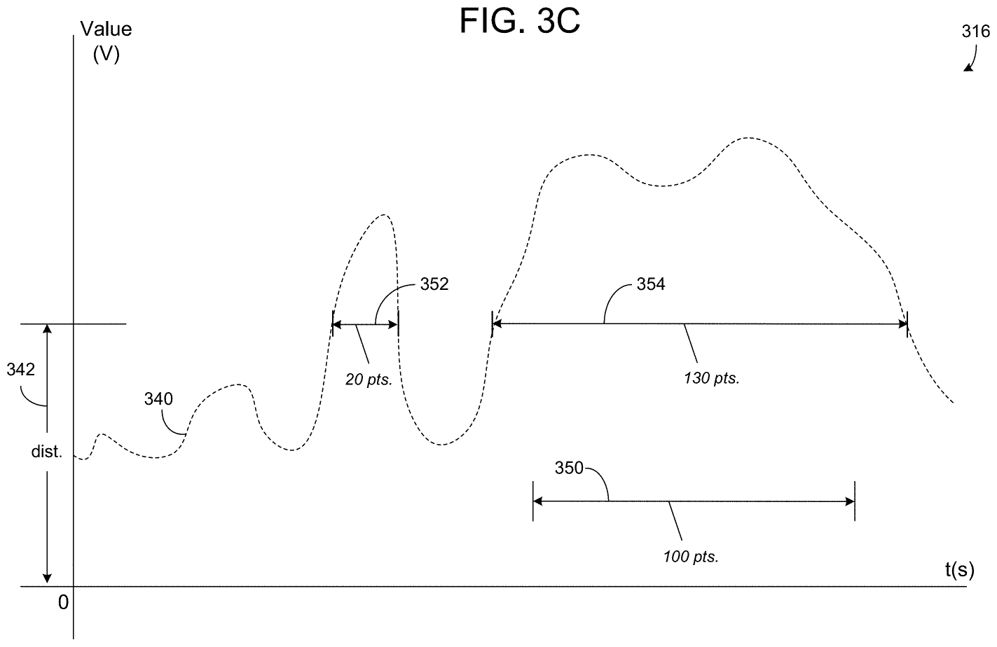

FIG. 3A illustrates a process 300 of determining to perform an ML model update in accordance with example embodiments. The process 300 may be performed by an edge device 220 and/or a cloud platform 230 as shown in the example of FIG. 2. Each step within the process 300 may be performed by one or more of the edge and the cloud, but there are no limitations as to which system performs which step. In some cases, all steps may be performed by the edge device, all steps may be performed by the cloud platform, or some steps may be performed by the edge device and some steps may be performed by the cloud platform. The embodiments are not limited thereto. The process 300 provides for automatically determining when a ML model (e.g., an AI model, etc.) in the cloud should be updated with respect to new data pattern being seen at the corresponding edge device.

Referring to FIG. 3, in 311 data is acquired from an operation of an asset. The data may be time-series data that is collected by a sensor, a camera, a microphone, a thermometer, a gauge, or the like. To efficiently train/fine-tune an existing model without affecting the performance on previous task, the system may associate a representative dataset

$$D\_l = \{ dt\_ 1 , dt\_ 2 , … , dt\_ \text{?} , … , dt\_N \}$$

$$\text{?} \text{indicates text missing or illegible when filed}$$

having a fixed size N for a cloud model M_t. When new data arrives from the asset (at the edge or the cloud), in 312, the distance between a data sample x to the previously trained model may be calculated as in Equation 1.

$$Dist ( M\_t , x ) = sum\_ \{ \text{?} = 1 to N \} ‖ dt\_ \text{?} - x ‖ \text{/} N \\ \text{?} \text{indicates text missing or illegible when filed} \qquad Equation ( 1 )$$

In 313, the distance may be compared to a predetermined distance. When min_t dtst(M_t,x)<=tau, where tau is a predefined threshold, the system may associate the data sample x with the previously trained model M_t, otherwise, in 314, the sample x may be stored in a new data set referred to as Set X.

An example of a determining system 330 (e.g., cloud platform, edge device, etc.) assigning new data points from an operation of an asset 320 to a previous data set 332 or a new data 334 set is shown in the example of FIG. 3B. Here, the determining system 330 may determine whether a data point is a predetermined distance from a data pattern of the data set 332. The data pattern may be represented on a two-dimensional graph of sensed/acquired data over time. The distance determination may be a Euclidean distance as shown in the example of Equation 1. If the data point is at least a predetermined distance from the data pattern of the old data set 332, the determining system 330 may assign the new data point to the new data set 334. The determining system 330 may be the cloud platform. Alternatively, the above calculation can happen at the edge device level, and the data sample x is only sent to the cloud when min_t dtst(M_t,x)≥tau.

In 315, the determining system 330 may run a cluster program (using the point to set distance) which may be constantly run on Set X to separate the Set X into subsets of clusters. The clusters may be based on whether data points above the distance threshold are continuously received or if breaks occur and some data is still being received within an acceptable deviation of the old training data. In 316, the size of each cluster is compared with a threshold β, which is a predefined value representing a reasonable size to trigger a model update/training. When the size of any cluster within Set X is greater than or equal to beta, in 317 a model update/training will be triggered. The updated model may then be stored, in 318 and/or provided to one or more edge devices for use when reading data from the asset and sending it back to the cloud.

FIG. 3C a process 316 of clustering data within the new data set in accordance with example embodiments. Here, the data may be graphed over time to create a data graph line 340 of the acquired data. In this example, the data points may be compared to a predetermined distance threshold 342. When the data points are continuously above the distance threshold 342, the amount of time may be compared to a minimum data point threshold 350 which in this example is 100 data points. The first cluster 352 of data points is only 20 data points and is therefore not enough to satisfy the minimum threshold 350. Therefore, the first cluster 352 is not enough to trigger an update to the ML model. However, a second cluster 354 includes 130 data points which is greater than the minimum threshold of 100 data points. The second cluster 354 triggers an update to the ML model.

In the cloud (or even the edge), the models may be configured such that the design is incrementally upgradeable. There are various approaches to update an ML model. In one example, the new clustered data set may be used as an incremental input. Therefore, an incremental learning approach may be performed to update the existing model. As another example, a new model may be trained from scratch with the new data set. Then, the cloud may combine the new model with the original model directly to create the ML model update. As another example, the new data set may be merged with the original data set and a model may be trained based on the whole data set including the old data and the new data.

For incoming data from edge devices and cloud AI models, the matching between the two become challenging when the number of both parties starts to increase. To utilize the data effectively and train the model without sacrificing the performance on previous tasks, it is vital to match the right data to the right model and to create new models when a new data mode start to emerge. The example embodiments implement a mechanism by which an edge and a cloud can automatically trigger an update to a ML model when the data being acquired of the asset operation begins to deviate from the training data used to train the ML model. The system can determine the deviation has occurred and is not just a few outlier data points, but rather a change in data pattern being sensed/acquired of the asset operation.

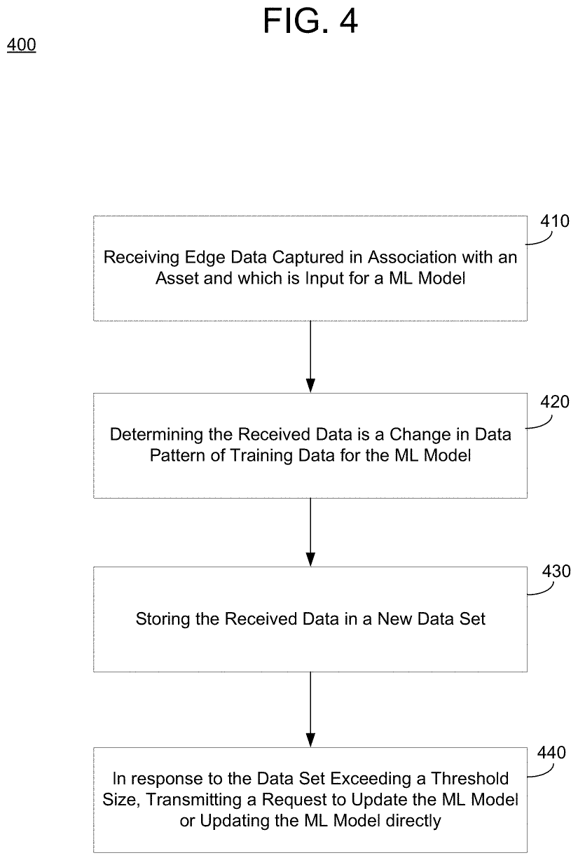

FIG. 4 illustrates a method 400 for determining to perform a ML model update in accordance with an example embodiment. For example, the method 400 may be performed by an edge device such as a computing system connected to or embedded within an industrial asset, a cloud computing platform, web server, a database, and the like, or a combination of devices such as a combination of a cloud platform and an edge computing system.

Referring to FIG. 4, in 410, the method may include receiving data of an operation performed by an industrial asset. According to various aspects, the received data may be an input for a ML model associated with the industrial asset. ML models can be used to predict future operating characteristics of the asset, predict maintenance needs, predict supply chain issues, and the like. The received data may be time-series data measured of one or more attributes over time. As an example, the received data may include sensor data captured of at least one of temperature, pressure, vibration, movement, displacement, and sound associated with the operation of the industrial asset. As another example, the received data may include one or more of images and video captured of the operation of the industrial asset.

In 420, the method may include determining the received data includes a change in data pattern with respect to a training data set used to previously train the ML model. For example, the determining the change in the data pattern may include determining that a distance between an incoming data point included in the received data is greater than a predetermined distance from data points of the training data set of the ML model. For example, data points within the received data may be compared to data patterns of training data of the ML model. Here, a distance such as a Euclidean distance between the incoming data point and the training data pattern may be computed to determine whether the incoming data point deviates from the training data pattern by a predetermined threshold distance.

When it is determined that the data point exceeds the threshold distance, in 430 the method may store the received data comprising the change in data pattern in a new data set. In some embodiments, the storing may include accumulating received data points that comprise the change in the data pattern within the new data set. In some embodiments, the method may include clustering of the accumulated data points into groups based on continuous occurrences of data points exceeding the threshold distance, and determining whether the cluster has a size greater than the minimum threshold size.

In response to the new data set reaching a minimum threshold size, in 440 the method includes at least one of updating the ML model based on the new data set and transmitting a request to update the ML model based on the new data set. For example, if the method is being performed by the edge device or a combination of the edge and the cloud, the method may include transmitting the new data set from an edge device to a cloud platform in response to the edge device determining that the training data set has reached a minimum threshold size. As another example, when the method is performed by the cloud platform the method may include updating the ML model based on the new data set in response to a cloud platform determining that the training data set has reached a minimum threshold size.

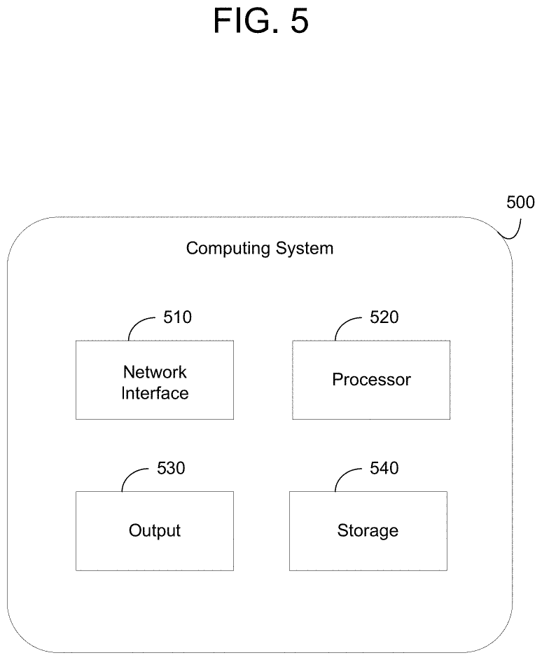

FIG. 5 illustrates a computing system 500 for use in accordance with an example embodiment. For example, the computing system 500 may be an edge computing device, a cloud platform, a server, a database, and the like. In some embodiments, the computing system 500 may be distributed across multiple devices such as both an edge computing device and a cloud platform. Also, the computing system 500 may perform the method 400 of FIG. 4. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, and the like.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like.

The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the method 400 shown in FIG. 4. Also, the storage 540 may store software programs and applications which can be downloaded and installed by a user. Furthermore, the storage 540 may store and the processor 520 may execute an application marketplace that makes the software programs and applications available to users that connect to the computing system 500.

According to various embodiments, the processor 520 may receive (e.g., via the network interface 510, etc.) data of an operation performed by an industrial asset. For example, the received data may include input for an ML model associated with the industrial asset. The processor 520 may determine the received data includes a change in data pattern with respect to a training data set used to previously train the ML model, and store the received data comprising the change in data pattern in a new data set within the storage device. Furthermore, in response to the new data set reaching a minimum threshold size, the processor 520 may at least one of update the ML model based on the new data set (when the computing system 500 is a cloud platform, server, etc.) and transmit a request to update the ML model based on the new data set (when the computing system 500 is a computing device associated with the edge/asset).

In some embodiments, the processor 520 may determine the change in the data pattern when a distance (e.g., a Euclidean distance) between a data point included in the received data is greater than a predetermined distance from data points of the training data set of the ML model. In some embodiments, the processor 520 may accumulate received data points that comprise the change in the data pattern within the new data set. In some embodiments, the processor 520 may cluster the accumulated data points into a cluster and determine whether the cluster has a size greater than the minimum threshold size. When a cluster is detected that is greater than the minimum threshold size, the processor 520 may perform the update to the ML model based on the new data set, or it may request another device such as a cloud platform to perform the model update by transmitting a request to the cloud platform via the network interface 510.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage device; and
a processor configured to receive data of an operation performed by an industrial asset, the received data comprising input for a machine learning (ML) model associated with the industrial asset, determine the received data comprises a change in data pattern with respect to a training data set used to previously train the ML model, and store the received data comprising the change in data pattern in a new data set within the storage device,
wherein, in response to the new data set reaching a minimum threshold size, the processor is further configured to at least one of update the ML model based on the new data set and transmit a request to update the ML model based on the new data set.

2. The computing system of claim 1, wherein the received data comprises sensor data captured of at least one of temperature, pressure, vibration, movement, displacement, and sound associated with the operation of the industrial asset.

3. The computing system of claim 1, wherein the received data comprises one or more of images and video captured of the operation of the industrial asset.

4. The computing system of claim 1, wherein the processor determines the change in the data pattern when a distance between a data point included in the received data is greater than a predetermined distance from data points of the training data set of the ML model.

5. The computing system of claim 1, wherein the processor is configured to accumulate received data points that comprise the change in the data pattern within the new data set.

6. The computing system of claim 5, wherein the processor is configured to cluster the accumulated data points into a cluster and determine whether the cluster has a size greater than the minimum threshold size.

7. The computing system of claim 1, further comprising a network interface to transmit the new data set from an edge device to a cloud platform in response to the processor determining that the training data set has reached a minimum threshold size.

8. The computing system of claim 1, wherein the processor is further configured to update the ML model based on the new data set in response to a cloud platform determining that the training data set has reached a minimum threshold size.

9. A method comprising:
receiving data of an operation performed by an industrial asset, the received data comprising input for a machine learning (ML) model associated with the industrial asset;
determining the received data comprises a change in data pattern with respect to a training data set used to previously train the ML model;
storing the received data comprising the change in data pattern in a new data set; and
in response to the new data set reaching a minimum threshold size, at least one of updating the ML model based on the new data set and transmitting a request to update the ML model based on the new data set.

10. The method of claim 9, wherein the received data comprises sensor data captured of at least one of temperature, pressure, vibration, movement, displacement, and sound associated with the operation of the industrial asset.

11. The method of claim 9, wherein the received data comprises one or more of images and video captured of the operation of the industrial asset.

12. The method of claim 9, wherein the determining the change in the data pattern comprises determining that a distance between a data point included in the received data is greater than a predetermined distance from data points of the training data set of the ML model.

13. The method of claim 9, wherein the storing comprises accumulating received data points that comprise the change in the data pattern within the new data set.

14. The method of claim 13, wherein the storing comprises clustering the accumulated data points into a cluster and determining whether the cluster has a size greater than the minimum threshold size.

15. The method of claim 9, wherein the method comprises transmitting the new data set from an edge device to a cloud platform in response to the edge device determining that the training data set has reached a minimum threshold size.

16. The method of claim 9, wherein the method comprises updating the ML model based on the new data set in response to a cloud platform determining that the training data set has reached a minimum threshold size.

17. A non-transitory computer readable medium having stored therein instructions that when executed cause a computer to perform a method comprising:
receiving data of an operation performed by an industrial asset, the received data comprising input for a machine learning (ML) model associated with the industrial asset;
determining the received data comprises a change in data pattern with respect to a training data set used to previously train the ML model;
storing the received data comprising the change in data pattern in a new data set; and
in response to the new data set reaching a minimum threshold size, at least one of updating the ML model based on the new data set and transmitting a request to update the ML model based on the new data set.

18. The non-transitory computer readable medium of claim 17, wherein the received data comprises sensor data captured of at least one of temperature, pressure, vibration, movement, displacement, and sound associated with the operation of the industrial asset.

19. The non-transitory computer readable medium of claim 17, wherein the received data comprises one or more of images and video captured of the operation of the industrial asset.

20. The non-transitory computer readable medium of claim 17, wherein the determining the change in the data pattern comprises determining that a distance between a data point included in the received data is greater than a predetermined distance from data points of the training data set of the ML model.
